(19) United States
(12) Patent Application Publication
(10) Pub. No.: US 2007/0074035 A1
(43) Pub. Date: Mar. 29, 2007

(54) Secure recordation for inspection systems and methods

(76) Inventors: Tom Scanlon, Hampstead, NH (US); James T. Woolaway, Santa Barbara, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/239,531

(22) Filed: Sep. 29, 2005

(51) Int. Cl. H04L 9/00

(52) U.S. Cl. 713/176

(57) ABSTRACT

In accordance with at least one embodiment of the present invention, a portable inspection system is configured to capture inspection data, such as for example an infrared image. The inspection data is securely recorded (e.g., with an encryption algorithm) along with associated information, which may include for example date, time, system settings, operator identification, and location.

### TECHNICAL FIELD

The present invention relates generally to secure recordation and inspection systems, and more particularly, for example, to infrared inspection systems.

### RELATED ART

Environmental and safety concerns may require periodic monitoring of production facilities, which may utilize toxic, flammable, or controlled substances. In some production facilities, these substances pass through hundreds of pressurized pipes and tanks having thousands of seals, seams, and joints at various locations. In some cases, periodic inspection of the facilities at these locations must be documented in order to comply with various regulatory agency requirements. Failure to adequately document compliance with the requirements can result in a levy of fines against the offending facility and a halt to ongoing production until compliance can be verified.

With such a strong motivation to document compliance, there is also a possibility of fraud or inadvertent failures to properly comply. For example, an individual may wish to falsify a compliance report to indicate an area of the production facility was inspected, when it was not (e.g., only a portion of an inspection route was completed, while some other portion was not completed). Furthermore, an inspection procedure may require the inspector to be certified in some particular inspection capacity. Because it may be more expensive to acquire services from a certified inspector, there may be an attempt to utilize uncertified people. In this case, the inspection may have been completed, but may have been accomplished by an uncertified or unqualified person. In view of these issues and others, there remains a need in the art for improved inspection systems that can reduce fraud and facilitate a more complete inspection or more trustworthy compliance verification.

### SUMMARY

Systems and methods are disclosed herein, in accordance with one or more embodiments of the present invention, to provide secure recordation of inspection data, such as for example for infrared (IR) images within an infrared camera or to secure other types of inspection data within an inspection system (e.g., a portable inspection tool). As an example in accordance with an embodiment of the present invention, a camera system is disclosed for recording infrared images (e.g., one or more single frames or real time video), with the images securely recorded with the time and date of the recordation. The camera system may optionally include additional features to obtain additional information associated with the recordation. For example, information on the operator of the camera system, location, camera orientation, and/or camera recordation settings may be obtained at the time of the recordation and securely associated with the corresponding images.

More specifically in accordance with an embodiment of the present invention, an inspection system is disclosed to capture infrared images and to securely record date, time, and/or other relevant information along with the captured image. For example, the inspection system may securely record the information by employing a cryptographic hash function and a private key to sign the information and store for later verification. Alternatively or in addition, the infrared images may be encrypted using an encryption algorithm.

In accordance with another embodiment of the present invention, an infrared camera system includes an infrared camera adapted to capture image data of a target; and a processor adapted to provide a signature for the image data and associated information, wherein the associated information provides at least one of a location of the infrared camera, an orientation of the infrared camera, operator information of the infrared camera, a time of the image data capture, a date of the image data capture, camera settings, and target information.

In accordance with another embodiment of the present invention, a portable inspection system includes means for inspecting a target to obtain inspection data; means for obtaining a first set of information associated with the inspection data, wherein the first set of information comprises at least one of a setting of the inspecting means, a location of the inspecting means, an orientation of the inspecting means, operator information of the inspecting means, a time of obtaining the inspection data, a date of obtaining the inspection data, and target information; and means for generating a signature for the inspection data and the first set of information associated with the inspection data.

In accordance with another embodiment of the present invention, a method of securely recording inspection data within a portable inspection system includes inspecting a target with the inspection system to obtain inspection data; determining at least one of target information and a location of the inspection system during the inspecting operation; determining a time and a date for the inspecting operation; and securing the inspection data, the time, the date, and at least one of the location and the target information within the inspection system with an encryption algorithm.

The scope of the present invention is defined by the claims, which are incorporated into this section by reference. A more complete understanding of embodiments of the present invention will be afforded to those skilled in the art, as well as a realization of additional advantages thereof, by a consideration of the following detailed description. Reference will be made to the appended sheets of drawings that will first be described briefly.

### BRIEF DESCRIPTION OF THE DRAWINGS

FIG. 1 shows an inspection station where an inspector is operating an inspection system to examine an inspection target for a possible gas leak, in accordance with an embodiment of the present invention.

FIG. 2 shows a block diagram view of an inspection system, in accordance with an embodiment of the present invention.

FIG. 3 shows a block diagram view of an inspector identification unit, in accordance with an embodiment of the present invention.

FIG. 4 shows a block diagram view of a position determination unit, in accordance with an embodiment of the present invention.

FIG. 5 shows a block diagram view of a target identification unit, in accordance with an embodiment of the present invention.

FIG. 6 shows a block diagram view of a video processing unit, in accordance with an embodiment of the present invention.

FIG. 7 shows a block diagram view of a security processing unit, in accordance with an embodiment of the present invention.

FIG. 8 shows an inspection flow, in accordance with an embodiment of the present invention.

FIG. 9 shows an exemplary signing of the infrared image data in accordance with an embodiment of the present invention.

FIG. 10 shows an exemplary verification of the signed infrared image data of FIG. 9 in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

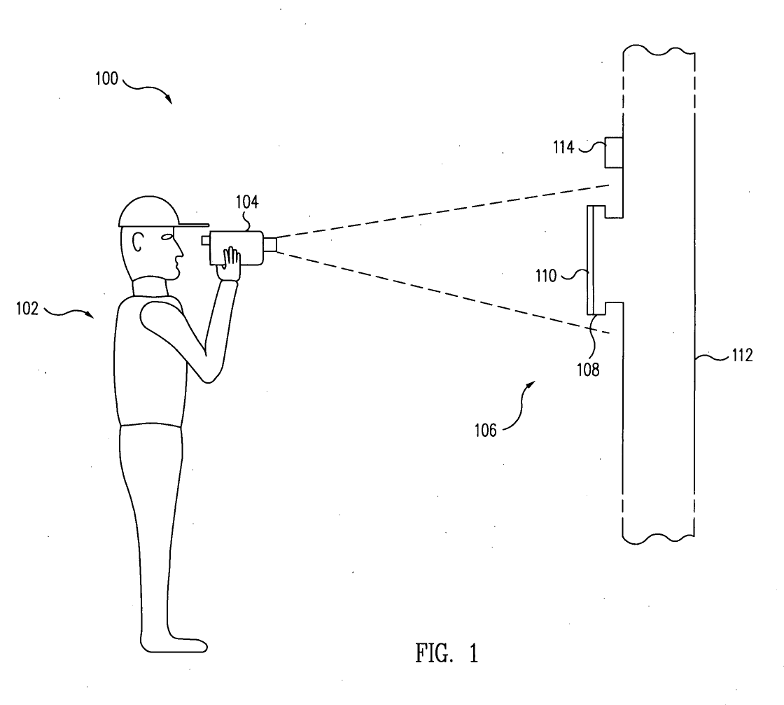

FIG. 1 shows an inspection station 100, in accordance with an embodiment of the present invention, where an inspector 102 is operating an inspection system 104 to examine an inspection target 106 (e.g., for a possible gas leak). Target 106, for example, can be any component of a production facility. As an example, target 106 may have a juncture 108 between a cover plate 110 mounted on a pipe 112 that conducts a gas or gas-emitting substance. In this example, plate 110 is intended to seal the juncture 108 by compressing a gasket (not shown) between plate 110 and pipe 112 so that a failure in the gasket might result in a gas leak that is detected by inspection system 104. Alternatively, any portion of any component at inspection station 110 may be inspected since any portion of the pipe 112 or assembled plate 110 may develop a breach where gas may leak out. An inspection target identifier 114 can be mounted on or near inspection target 106. Inspection target identifier 114 may be used for identifying an associated inspection target 106 or inspection station 100, as explained further herein.

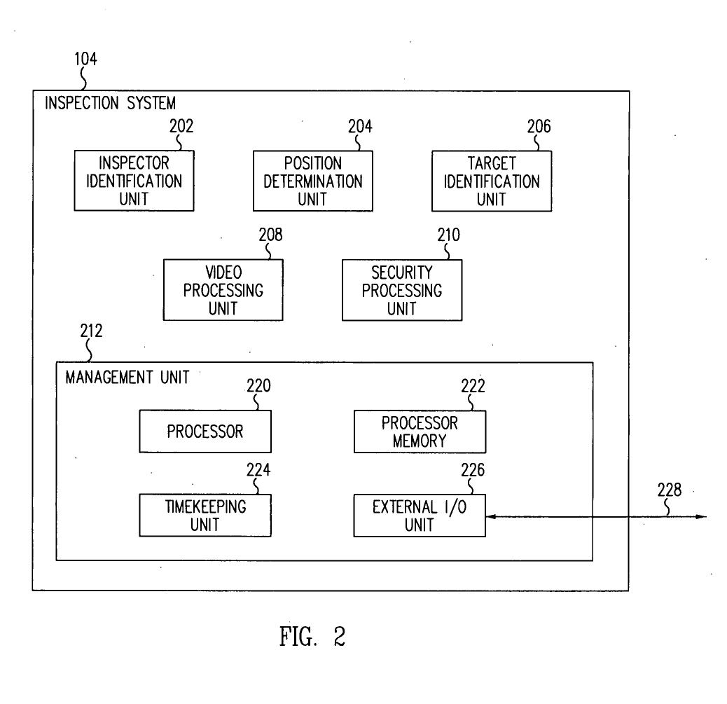

FIG. 2 shows an exemplary block diagram view of inspection system 104 in accordance with an embodiment of the present invention. Inspection system 104 may include an inspector (operator) identification unit 202, a position determination unit 204, a target identification unit 206, a video processing unit 208, a security processing unit 210, and/or a management unit 212. Management unit 212 communicates with and controls inspector identification unit 202, position determining unit 204, target identification unit 206, video processing unit 208, and security processing unit 210 to securely capture one or more video images of an inspection target (e.g., when the identity of the inspection system operator is recorded or verified and the position of the inspection system is determined or match pre-defined or predetermined conditions).

Management unit 212 includes a processor 220 and a processor memory 222, such as a suitably programmed microcomputer. Processor 220 controls communications within inspection system 104 and may perform computations to implement inspection algorithms. Processor memory 222 can be implemented in one or more technologies including a Random Access Memory (RAM), Read Only Memory (ROM), a magnetic disc, an optical disc, or other data storage and retrieval mediums. Processor 220 reads and executes instructions contained within processor memory 222 to operate inspection system 104, for example, to perform computations and communicate within inspection system 104.

In order to accurately monitor the time and date of inspection events, management unit 212 may include a timekeeping unit 224 that can generate time and date information for use in marking captured images. Alternatively, time and date information for inspection system 104 may be obtained from position determination unit 204 (e.g., GPS) and, thus, timekeeping unit 224 would not be required. Management unit 212 may also record the position of inspection system 104 for an operator traversing an inspection route using position information provided by position determination unit 204. Finally, management unit 212 includes an external input/output unit 226 that is configured to send and receive data and instructions over an external connection 228 that can be implemented as a wireless connection (e.g., RF or optical link) or a wired connection, with one or more devices enabled to send information to or receive information from inspection system 104. Processor 220 can also communicate over external connection 228 with an Internet server to transfer information, such as for example synchronization information for timekeeping unit 224.

It should be understood that the block diagram of inspection system 104 (FIG. 2) represents exemplary functional aspects of inspection system 104. Therefore, one or more functional blocks may be optional (e.g., inspector identification unit 202, position determination unit 204, target identification unit 206, and/or timekeeping unit 224 may be optional), depending upon the application or requirements. Furthermore, one or more of the functional blocks of inspection system 104 (FIG. 2) may be combined to share common functions or circuitry (e.g., common processor or memory). For example, management unit 212 may represent the control and processing functions for inspection system 104 and include various functional aspects of inspection system 104 (e.g., including and performing security processing unit 210 functions) and/or may be included within one or more of the functional blocks of inspection system 104 (e.g., within video processing unit 208). In general, the exemplary block diagram view of inspection system 104 in FIG. 2 may be viewed as a processor or other type of controller to perform the inspection functions of inspection system 104 and to securely record the inspection data and associated information, as disclosed herein.

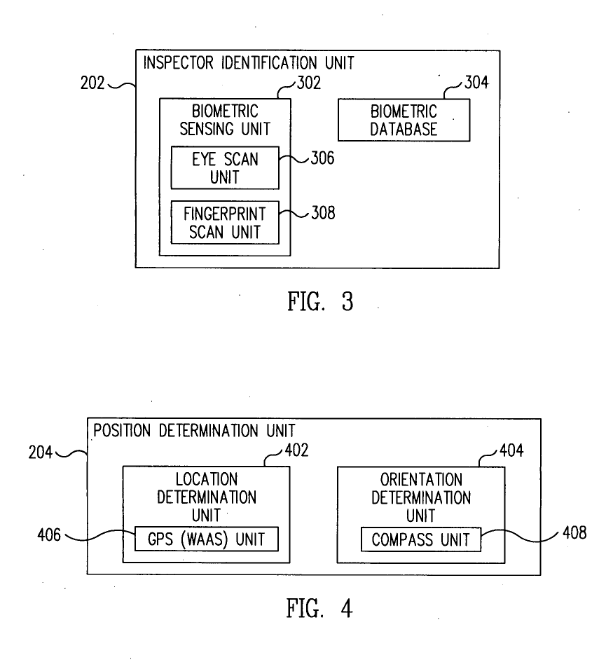

FIG. 3 shows an exemplary block diagram view of inspector identification unit 202 in accordance with an embodiment of the present invention. Inspector identification unit 202 may employ biometric technology and include a biometric sensing unit 302, for sensing or reading a biometric attribute of an inspection system operator, and a biometric database 304, for storing and retrieving biometric data corresponding to one or more operators. For example, biometric sensing unit 302 can read a fingerprint or thumbprint of an operator to capture a biometric sample that is stored in biometric database 304 and/or compared with biometric sample data stored in biometric database 304. Similarly, biometric sensing unit 302 can examine the eye of an operator to capture a biometric sample that is stored in biometric database 304 and/or compared with biometric sample data stored in biometric database 304.

As an example, if the biometric sample taken by biometric sensing unit 302 matches the information stored in biometric database 304, the operator can be authenticated as an authorized operator either during an inspection operation, or to unlock or activate the inspection system prior to use. In this manner, inspector identification unit 202 is configured to record and/or determine the identity of an operator of inspection system 104. Biometric data stored in biometric database 304 can be loaded from previously captured operator data or may be loaded through an initial operator validation process. Alternatively, the identification of the inspector may be obtained through a keypad or operator input, such as a corresponding password or secure key (e.g., secure RSA key, discussed further herein).

FIG. 4 shows an exemplary block diagram view of position determination unit 204 in accordance with an embodiment of the present invention. Position determination unit 204 may include a location determination unit 402 and/or an orientation determination unit 404 to provide position information of inspection system 104. Location determination unit 402 can include a Global Positioning Satellite (GPS) unit 406. In order to achieve higher accuracy, GPS unit 406 may be enabled with Wide Area Augmentation System (WAAS) technology where GPS unit 406 receives a correction signal generated based on data from a plurality of ground reference stations to further refine the accuracy of the position information. Other technologies such as Differential GPS (DGPS) may also be used in order to improve position detection accuracy. Alternatively, location determination unit 402 may employ other location determination techniques, using for example cellular signals (e.g., triangulation) or other GPS-type or wide area network signal location techniques.

Orientation determination unit 404 can include a compass unit 408 for measuring the rotational position of inspection system 104 based on a reference heading. For example, compass unit 408 can measure the rotational deviation of inspection system 104 as measured from a magnetic north direction based on the earth's magnetic field. Other rotational deviations may be detected on up to three orthogonal axes using various gyroscopic technologies. Rotation on these three axes may be used to specify the pan and tilt of inspection system 104 in order to clearly document the location, position, and viewing angle of an inspection system operator.

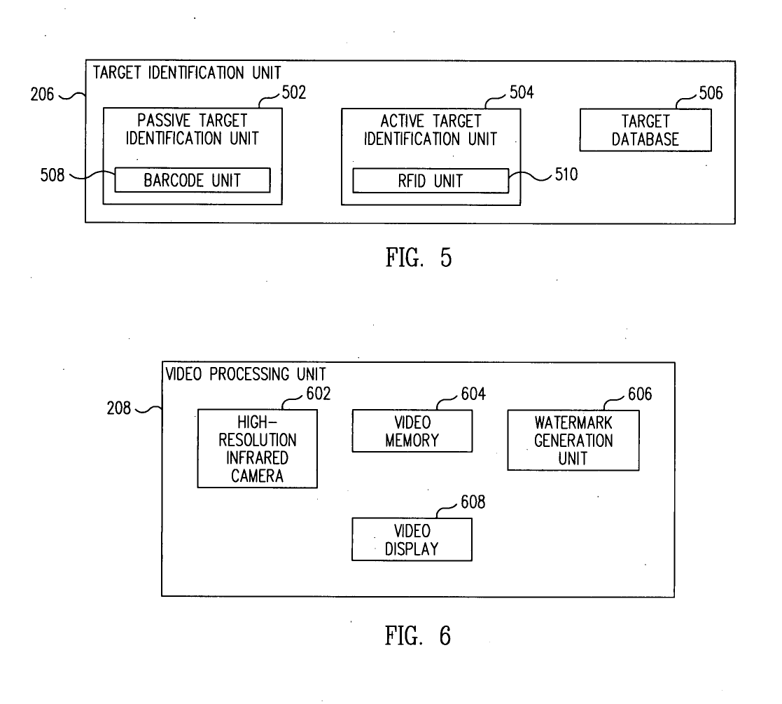

FIG. 5 shows an exemplary block diagram view of target identification unit 206 in accordance with an embodiment of the present invention. Target identification unit 206 may include a passive target identification unit 502, an active target identification unit 504, and/or a target database 506 for storing and retrieving target information. In reference to both FIGS. 1 and 5, target identifier 114 can include a passive device for reading by a scanner such as a bar code or other line-of-sight readable symbol in order to identify an inspection target. Alternatively or in addition, target identifier 114 can include an active device such as a Radio Frequency Identification (RFID) tag that does not require direct line-of-sight access in order to identify the inspection target. RFID units respond to a radio frequency (RF) query from an RFID reader and reply with tag information that is used to identify the inspection target. Any combination of passive and active target identifiers may be used including, for example, an active target identifier for identifying a station or general region of inspection having a plurality of inspection targets, where each target at the station is identified with a passive target identifier.

Passive target identification unit 502 can read a passive target identifier 114 and produce target identifier information (e.g., serial number or other information) that is used to identify an associated inspection target 106 or station 100. This identifying information may be associated with a particular inspection target 106 or inspection station 100 so that, by reading the target identifier, one can determine the inspection target or station. Passive target identification unit 502 can include a barcode unit 508 to read a passive target identifier such as a barcode, while active target identification unit 504 can include an RFID unit 510 to read from and/or write to an active target identifier such as an RFID tag. Target database 506 includes a memory for storing and retrieving target identifier information for a plurality of target identifiers as well as association information to link each target identifier with an inspection target, station, or both. Therefore, an inspection target is identified, for example, when the passive and/or active target identification information matches target database information in the target database.

FIG. 6 shows an exemplary block diagram view of video processing unit 208 in accordance with an embodiment of the present invention. Video processing unit 208 may include an infrared camera 602 (e.g., a high-resolution IR camera), a video memory 604, a watermark generation unit 606, and a video display 608. Camera 602 is configured to capture still and/or moving infrared images and produce image signals representing the captured images. Camera 602 may capture, for example, an image having picture elements, or pixels, with approximately 65,536 shades or gradations on a grayscale from white to black to detect gas leaks that cannot be recognized by a human observer, but that are visible using the high-resolution provided by camera 602. The high-resolution images captured by camera 602 may be coarsened to only 256 gradations to save memory storage space once the desired features from the image have been extracted or a lower resolution image is sufficient for the desired application.

The image signals from camera 602 are converted into a digital image format that can be stored in and retrieved from video memory 604. The captured images may be stored in a raw format or a standard format complying with an industry standard such as the Joint Photographic Experts Group (JPEG) family of standards, or Moving Picture Experts Group (MPEG) family of standards, for example. Video display 608 can be used to replay captured images for review by the inspector or others. Exemplary embodiments of camera 602 may include the Photon or Micro thermal imaging systems manufactured by Flir Systems™, Incorporated (Indigo Operations) of Goleta, Calif.

Watermark generation unit 606 may optionally be included to receive the digital image information and produce a new digital image having embedded information intended to identify (e.g., authenticate) the new image. The term watermark derives from the historical practice of including faintly visible words or graphics with a printed document, often within the actual paper before printing, where the words or graphics are designed to verify the authenticity or validate the source of the printed document. In traditional digital watermarking, a hidden pattern of information bits are inserted into a digital image file that provides copyright information related to the image such as the author's name, or contact information for reproduction rights, for example. In this disclosure, the term watermarking includes any practice of inserting any information into the digital image related to the captured image or the current state (e.g., date, time, position, and/or operator) of inspection system 104.

In addition to or instead of altering the digital image file, the identifying (e.g., authenticating) information may be included in a header file appended to, collocated, or associated with the captured image file data. The header and/or embedded information can include any information related to the captured image or the current state of inspection system 104, including the date and/or time of image capture, the operator, the location and/or orientation of inspection system 104 during image capture, and the target identifier information, for example. The header and/or embedded information, for example, can also include camera setting information on how the image was recorded, such as whether an image was considered radiometric or non-radiometric. For this disclosure, the term radiometric includes an assessment of a camera's ability to accurately convert radiated energy to object temperatures. For documentation purposes it may be desirable to record, with the radiometric image data, camera radiometric parametric data such as emissivity settings, background temperature values, optics parameters, filter parameters, target distance, and/or camera range settings. These parameters can also be stored, for example, in the image header file.

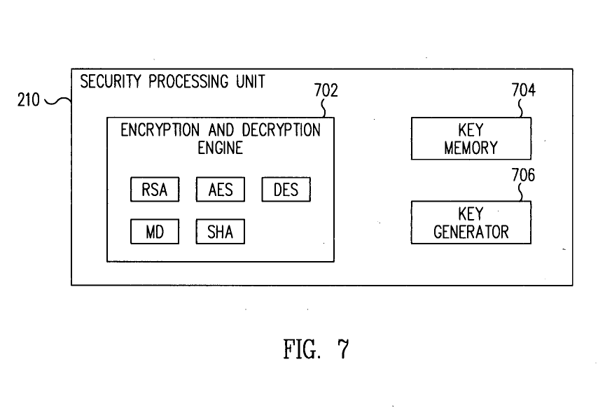

Furthermore, watermark generation unit 606 may be used to produce a new header having embedded information or the watermark could be appended to the header. The header and/or embedded information can also include an encrypted or plaintext signature for authentication of the image. For example, in reference to FIG. 7, security processing unit 210, in accordance with an embodiment of the present invention, provides encryption and decryption processing for information related to the watermark, image file, and/or header (e.g., the image header file and/or embedded information). Security processing unit 210 includes an encryption and decryption engine 702, a key memory 704, and a key generator 706. Engine 702 provides encryption and decryption processing according to any one of several private or public key encryption or signature algorithms including the RSA algorithm (by RSA Security of Bedford, Mass.), the Digital Encryption Standard (DES), the Advanced Encryption Standard (AES), and broad families of signature or hash algorithms such as the Secure Hash Algorithm (SHA) and the Message Digest (MD) algorithm. Key memory 704 is configured to store and retrieve cryptographic keys. Key generator 706 is configured to generate a new cryptographic key.

The header and/or embedded (e.g., watermark) information discussed above may be secured by encryption prior to inclusion within the image data (e.g., secure header or embedded information along with the image information in order to identify and validate the captured image). For example, information exchanged with an active target identifier, such as an RFID, may be secured within the header (or watermark) through encryption. Additionally for example, a secure time and date stamp, operator identification, orientation, camera settings (e.g., radiometric information), and/or location may be recorded within the header (or watermark).

In general depending upon the level of security desired and the specific requirements or applications, the image data (e.g., high resolution data) may not have to be encrypted. For example, by not encrypting the image file, considerable savings may be achieved in terms of processing, power savings, time, and/or memory. Thus, the image data may be securely recorded and validated by generating an associated signature that can be verified. Consequently, the image data is viewable and useable in a conventional fashion (e.g., using conventional imaging or display techniques), but is also verifiable through the signature.

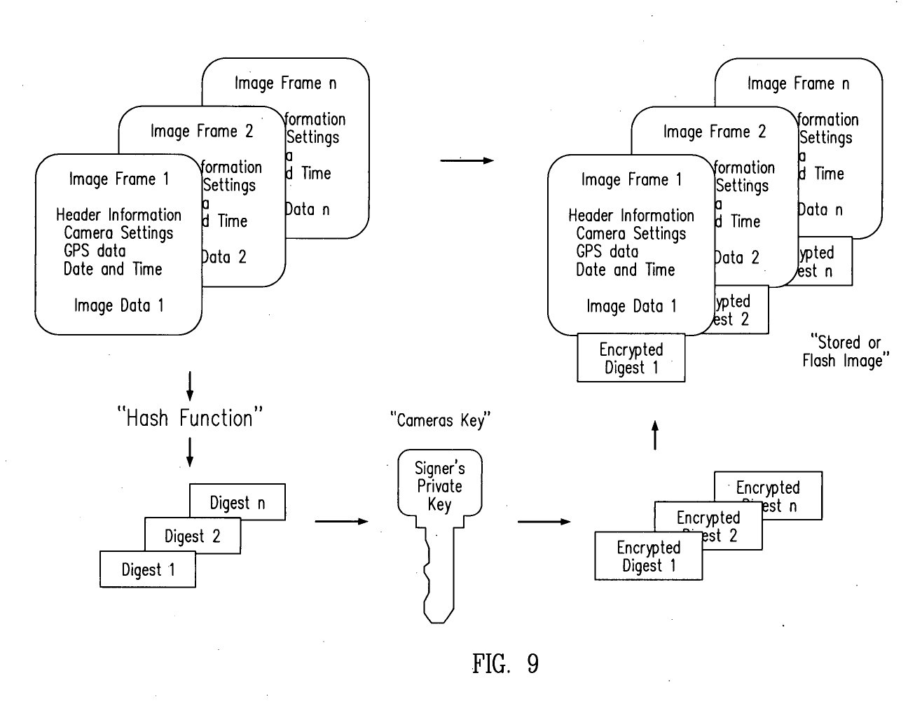

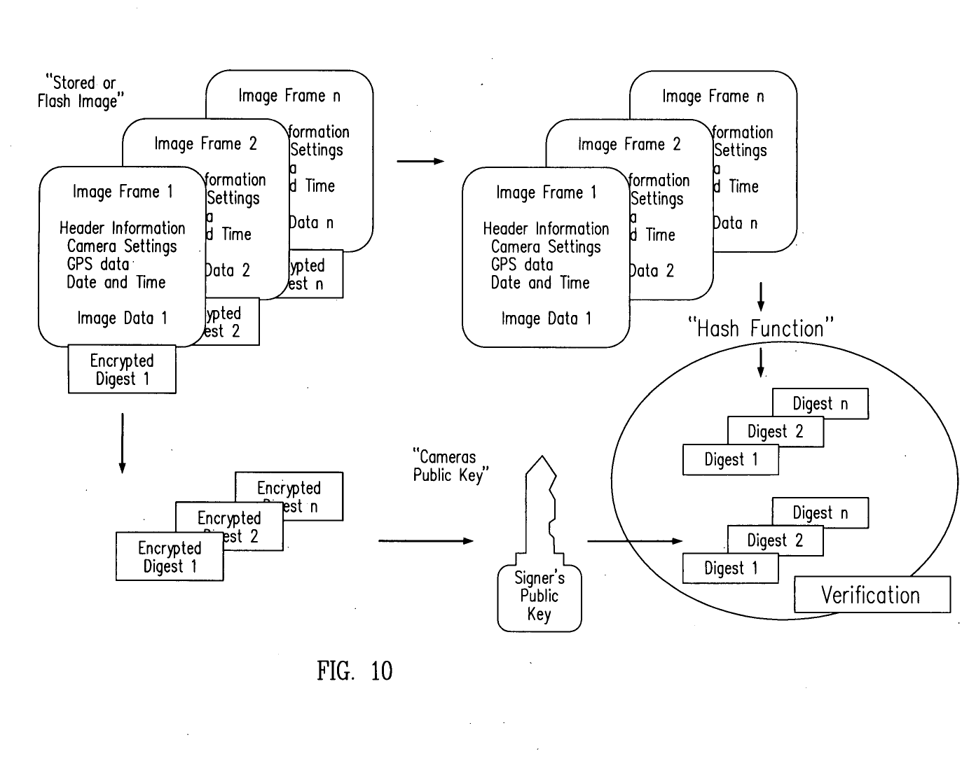

As an example, referring briefly to FIGS. 9 and 10, an example of data encryption or secure recordation for inspection system 104 is provided in accordance with an embodiment of the present invention. For this exemplary data encryption, a public private key infrastructure (PKI) is employed to generate a cryptographic signature for the image data (e.g., high resolution single frame or video data from video processing unit 208) and the header data (e.g., camera settings, location, orientation, date, time, operator information, and/or target information).

As shown in FIG. 9, the image frame data (e.g., header and digital image data) is hashed and then signed with a private key located within inspection system 104 (e.g., within security processing unit 210, which may be provided by the operator of inspection system 104 and serve as an operator identification). The signed image information may then be stored and/or used as image information is normally used for camera applications, but with the added benefit of being fully verifiable via the associated encrypted digest information.

The verification is accomplished, as illustrated in FIG. 10, by rehashing the encrypted digest information and decrypting the signature with a public key, with the resulting digest information verified by comparing to the hashed image frame data. The image data and the header data cannot be tampered with without the private key, which is stored in inspection system 104.

The encrypted header or embedded information may be included, for example, based on the inspection route traveled by the inspector (e.g., to provide route-key tagging). The inspection route may be recorded, for example, because for each image, the location and time may be stored in the header and signed and, thus, a secure record of the inspection route is created. As an example, as an operator moves through a facility with inspection system 104 to inspect various targets, the location, operator, time, date, radiometric parameters, and/or target information is stored along with the corresponding image data. The image with header information is hashed and signed with the signature stored with the image. This information may then be reviewed via inspection system 104 or by downloading the information to a server or other type of data station (e.g., a computer or processor-based storage device) to verify the route traveled and the results of the inspections. Furthermore, the information may be downloaded and stored based upon the location or target information provided by inspection system 104. An external time or event server (not shown) may also be used to synchronize and report the time (e.g., tag time) or other event such as the inspection system entering a particular inspection location, time on station, and/or time traveling between stations, for example. The image date may be rehashed and the signature validated with the public key.

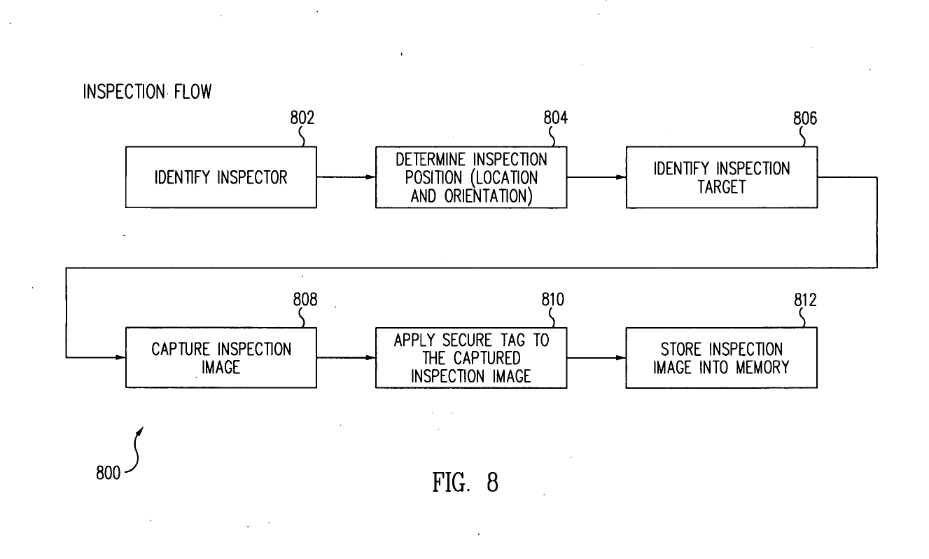

FIG. 8 shows an exemplary inspection flow 800 in accordance with an embodiment of the present invention. Inspection flow 800 includes identifying an inspector or operator of the inspection system in operation 802, determining an inspection position in operation 804, identifying an inspection target in operation 806, capturing inspection data (e.g., an image) in operation 808, applying a secure tag (e.g., signature) to the inspection image in operation 810, and storing the tagged inspection image into a memory in operation 812. The tagged inspection image may be later transferred out of inspection system 104 to a server, a user, or a storage device through external connection 228, as shown in FIG. 2. It should be understood that one or more operations illustrated in inspection flow 800 may be optional, depending upon the application or inspection requirements.

Operation 802 includes, for example, operating inspector identification unit 202 to identify and/or record the inspector prior to performing an inspection (e.g., in order to avoid the case where an unauthorized or uncertified person may perform the inspection), as discussed in reference to FIGS. 2 and 3. Operation 804 includes operating position determination unit 204 in order to determine the location and orientation of inspection system 104, as discussed in reference to FIGS. 2 and 4. Operation 806 includes operating target identification unit 206 to identify an inspection target using one or more active or passive target identifiers, as discussed in reference to FIGS. 2 and 5. Operation 808 includes operating video processing unit 208 to capture one or more images and optionally applying a watermark, as discussed in reference to FIGS. 2 and 6. Operation 810 includes applying a secure tag to the captured inspection image (e.g., encrypting by signing or otherwise encoding information to secure the image data and associated information), as discussed in reference to FIGS. 2, 7, 9, and 10.

Systems and methods are disclosed herein to provide an inspection system in accordance with one or more embodiments of the present invention. For example, a video processing unit 208 (e.g., an IR camera) was disclosed in accordance with an embodiment of the present invention as part of inspection system 104. However, it should be understood that video processing unit 208 may be substituted with a different inspection tool, depending upon the desired application, or additional inspection tools may be included within inspection system 104. For example, an ultrasonic analysis system may be included with or substituted for video processing unit 208 to provide fault isolation and detection of a mechanical system (e.g., imminent bearing failure within a motor). As another example, a vibration analyzer or a lubrication analyzer (e.g., oil analyzer) may be included with or substituted for video processing unit 208 to provide the desired inspection system for the desired applications. The data from these systems (e.g., ultrasonic analysis system, vibration analyzer, and/or lubrication analyzer) may be encrypted or otherwise secured in a similar fashion as was described for the image data from video processing unit 208 of inspection system 104.

The inspection systems and methods disclosed herein may be employed, for example in accordance with one or more embodiments of the present invention, in a wide variety of applications. For example, an inspection system may be utilized to provide production facility monitoring and compliance verification, security surveillance, nuclear power plant predictive and preventative maintenance, and other monitoring and surveillance or compliance activities. As another example, an inspection system may be utilized by law enforcement or military to record engagements or record arrest or pursuit activities with secure recordation of the data (e.g., for evidentiary functions).

Embodiments described above illustrate but do not limit the invention. It should also be understood that numerous modifications and variations are possible in accordance with the principles of the present invention. Accordingly, the scope of the invention is defined only by the following claims.

We claim:

1. An infrared camera system comprising:
an infrared camera adapted to capture image data of a target; and
a processor adapted to provide a signature for the image data and associated information, wherein the associated information provides at least one of a location of the infrared camera, an orientation of the infrared camera, operator information of the infrared camera, a time of the image data capture, a date of the image data capture, camera settings, and target information.

2. The infrared camera system of claim 1, wherein watermark information is inserted into at least one of the image data, the associated information, and a header for the image data by at least one of the infrared camera and the processor.

3. The infrared camera system of claim 1, further comprising a target identification unit adapted to obtain the target information of the target, wherein the target identification unit comprises at least one of an RFID reader and a barcode reader.

4. The infrared camera system of claim 1, wherein the processor encrypts at least one of the image data and the associated information by executing an encryption algorithm comprising at least one of an RSA algorithm, a DES algorithm, an AES algorithm, an SHA algorithm, and an MD algorithm.

5. The infrared camera system of claim 1, wherein the processor provides the signature for the image data and the associated information by hashing the image data and the associated information and signing with a private key to generate a cryptographic signature.

6. The infrared camera system of claim 1, further comprising a position determination unit adapted to obtain at least the location of the infrared camera and the orientation of the infrared camera.

7. The infrared camera system of claim 1, further comprising an operator identification unit adapted to obtain the operator information of the infrared camera, wherein the operator information comprises at least one of a fingerprint and an eye scan.

8. The infrared camera system of claim 1, further comprising a timekeeping unit adapted to provide at least one of the time and the date of the image data capture.

9. The infrared camera system of claim 1, further comprising an input/output interface adapted to provide the image data along with the associated information.

10. A portable inspection system comprising:
means for inspecting a target to obtain inspection data;
means for obtaining a first set of information associated with the inspection data, wherein the first set of information comprises at least one of a setting of the inspecting means, a location of the inspecting means, an orientation of the inspecting means, operator information of the inspecting means, a time of obtaining the inspection data, a date of obtaining the inspection data, and target information; and
means for generating a signature for the inspection data and the first set of information associated with the inspection data.

11. The portable inspection system of claim 10, wherein the inspecting means comprises at least one of an infrared camera, an ultrasonic analysis system, a vibration analyzer, and a lubrication analyzer.

12. The portable inspection system of claim 10, further comprising means for watermarking at least one of the inspection data, the first set of information, and a header for the inspection data.

13. The portable inspection system of claim 10, wherein the generating means generates a cryptographic signature for the inspection data and the first set of information associated with the inspection data.

14. The portable inspection system of claim 10, further comprising means for providing the inspection data and the first set of information associated with the inspection data from the inspection system.

15. The portable inspection system of claim 10, further comprising downloading the inspection data and the first set of information associated with the inspection data based on the first set of information.

16. A method of securely recording inspection data within a portable inspection system, the method comprising:
inspecting a target with the inspection system to obtain inspection data;
determining at least one of target information and a location of the inspection system during the inspecting operation;
determining a time and a date for the inspecting operation; and
securing the inspection data, the time, the date, and at least one of the location and the target information within the inspection system with an encryption algorithm.

17. The method of claim 16, wherein the inspection system comprises at least one of an infrared camera, an ultrasonic analysis system, a vibration analyzer, and a lubrication analyzer.

18. The method of claim 17, further comprising:
determining a setting of the inspection system; and
securing the setting of the inspection system along with the inspection data, the time, the date, and at least one of the location and the target information within the inspection system with the encryption algorithm.

19. The method of claim 18, further comprising:
determining operator information of the inspection system; and
securing the operator information of the inspection system along with the inspection data, the time, the date, and at least one of the location and the target information within the inspection system with the encryption algorithm.

20. The method of claim 19, further comprising watermarking at least one of the inspection data, the operator information, the time, the date, and at least one of the location and the target information.

21. The method of claim 16, wherein the securing comprises:
hashing the inspection data, the time, the date, and at least one of the location and the target information to generate digest information; and
signing the digest information to generate encrypted digest information.

22. The method of claim 16, further comprising repeating the method for a plurality of targets to provide a recorded inspection route.
